(19) United States
(12) Patent Application Publication
(10) Pub. No.: US 2026/0020046 A1
(43) Pub. Date: Jan. 15, 2026

(54) METHOD AND APPARATUS OF HANDLING BWP SWITCHING COMMAND BASED ON UE TYPE

(71) Applicant: Samsung Electronics Co., Ltd., Suwon-si, Gyeonggi-do (KR)

(72) Inventor: Anil AGIWAL, Suwon-si (KR)

(21) Appl. No.: 18/993,799

(22) PCT Filed: Jul. 28, 2023
(86) PCT No.: PCT/KR2023/011034

§ 371 Date: Jan. 13, 2025

(30) Foreign Application Priority Data
Aug. 3, 2022 (KR) 10-2022-0096640

(51) Int. Cl. H04W 72/51; H04W 72/0457; H04W 72/23

(52) U.S. Cl. CPC H04W 72/51; H04W 72/0457; H04W 72/23

(57) ABSTRACT

The disclosure relates to a 5G or 6G communication system for supporting a higher data transmission rate. The disclosure relates to a wireless communication system. Specifically. the disclosure relates to an apparatus and a method of handing BWP switching command based on UE type.

### TECHNICAL FIELD

The disclosure relates to a method and an apparatus of handing BWP switching command based on UE type.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure proposes an apparatus and a method of handing BWP switching command based on UE type.

The disclosure proposes an apparatus and a method for starting or restarting of a BWP inactivity timer related to a RedCap UE.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

In accordance with an aspect of the disclosure, a method performed by a terminal in a wireless communication system is provided. The method comprises: receiving, from a base station, a first message comprising configuration information related to at least one bandwidth part; receiving, from the base station, a second message comprising information indicating an active downlink bandwidth part from the at least one bandwidth part; switching to the active downlink bandwidth part; in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, starting or restarting a timer associated with a bandwidth part inactivity.

In an embodiment, the method further comprises in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, starting or restarting the timer associated with the bandwidth part inactivity.

In an embodiment, the method further comprises in case that the terminal is not the terminal of the reduced capability, the default downlink bandwidth part is not configured, and the active downlink bandwidth part is not the initial downlink bandwidth part and is not indicated by an identity of a dormant bandwidth part, starting or restarting the timer associated with the bandwidth part inactivity.

In an embodiment, the method further comprises in case that the default downlink bandwidth part is configured, and the active downlink bandwidth part is not indicated by an identity of the default downlink bandwidth part and is not indicated by an identity of a dormant bandwidth part, starting or restarting the timer associated with the bandwidth part inactivity.

In an embodiment, the first message comprises a radio resource control (RRC) reconfiguration message.

In an embodiment, the second message comprises downlink control information (DCI).

In accordance with an aspect of the disclosure, a method performed by a base station in a wireless communication system is provided. The method comprises: transmitting, to a terminal, a first message comprising configuration information related to at least one bandwidth part; transmitting, to the terminal, a second message comprising information indicating an active downlink bandwidth part from the at least one bandwidth part; and in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, starting or restarting a timer associated with a bandwidth part inactivity.

In an embodiment, the method further comprises in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, starting or restarting the timer associated with the bandwidth part inactivity.

In an embodiment, the method further comprises in case that the terminal is not the terminal of the reduced capability, the default downlink bandwidth part is not configured, and the active downlink bandwidth part is not the initial downlink bandwidth part and is not indicated by an identity of a dormant bandwidth part, starting or restarting the timer associated with the bandwidth part inactivity.

In an embodiment, the method further comprises in case that the default downlink bandwidth part is configured, and the active downlink bandwidth part is not indicated by an identity of the default downlink bandwidth part and is not indicated by an identity of a dormant bandwidth part, starting or restarting the timer associated with the bandwidth part inactivity.

In accordance with an aspect of the disclosure, a terminal in a wireless communication system is provided. the terminal comprises a transceiver; and a controller coupled with the transceiver and configured to: receive, from a base station, a first message comprising configuration information related to at least one bandwidth part. receive, from the base station, a second message comprising information indicating an active downlink bandwidth part from the at least one bandwidth part, switch to the active downlink bandwidth part, in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, start or restart a timer associated with a bandwidth part inactivity.

In accordance with an aspect of the disclosure, a base station in a wireless communication system is provided. the base station comprises a transceiver; and a controller coupled with the transceiver and configured to: transmit, to a terminal, a first message comprising configuration information related to at least one bandwidth part, transmit, to the terminal, a second message comprising information indicating an active downlink bandwidth part from the at least one bandwidth part, and in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, start or restart a timer associated with a bandwidth part inactivity.

### ADVANTAGEOUS EFFECTS OF INVENTION

According to an embodiment of the disclosure, an apparatus and a method of handing BWP switching command based on UE type are proposed.

According to an embodiment of the disclosure, an apparatus and a method for starting or restarting of a BWP inactivity timer related to a RedCap UE are proposed.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 is an example illustration of starting or restarting of a BWP inactivity timer according to this method of disclosure.

FIG. 2 is a diagram illustrating a configuration of a terminal according to the disclosure.

FIG. 3 is a diagram illustrating a configuration of a base station according to the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may also refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

A “base station (BS)” is an entity communicating with a user equipment (UE) and may be referred to as a BS, a base transceiver station (BTS), a radio access network (RAN), a node B (NB), an evolved NB (eNB), an access point (AP), a fifth generation (5G) NB (5GNB), or a next generation NB (gNB).

A “user equipment (UE)” is an entity communicating with a BS and may be referred to as a UE, a device, a mobile station (MS), a mobile equipment (ME), or a terminal.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, and/or large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases of the fifth generation wireless communication system is expected to address is enhanced Mobile Broadband (cMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an arca in which propagation reaches to be densely located in a specific direction by using a plurality of antennas. In this situation, aggregation of the plurality of antennas can be referred to as an antenna array, and each antenna included in the antenna array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

CA (carrier aggregation)/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED (radio resource control connected) is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC, there is only one serving cell comprising of the primary cell. For a UE in RRC_CONNECTED configured with CA/DC, the term ‘serving cells’ is used to denote the set of cells comprising of the Special Cell(s) (SpCell(s)) and all secondary cells (SCell(s)). In NR the term Master Cell Group (MCG) refers to a group of serving cells associated with the Master Node, comprising of the PCell (Primary cell) and optionally one or more SCells. In NR the term Secondary Cell Group (SCG) refers to a group of serving cells associated with the Secondary Node, comprising of the PSCell (Primary SCG cell) and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

UE states in fifth generation wireless communication system: In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC (radio resource control) states can further be characterized as follows:

In the RRC_IDLE, a UE specific DRX (discontinuous reception) may be configured by upper layers. The UE monitors short Messages transmitted with P-RNTI (paging RNTI (radio Network temporary identifier)) over DCI (downlink control information); monitors a Paging channel for CN (core network) paging using 5G-S-TMSI (5G-S-temporary mobile group identity); performs neighboring cell measurements and cell (re-)selection; acquires system information and can send SI (system information) request (if configured); performs logging of available measurements together with location and time for logged measurement configured UEs.

In RRC_INACTIVE, a UE specific DRX may be configured by upper layers or by RRC layer; UE stores the UE Inactive AS (access stratum) context; a RAN-based notification area is configured by RRC layer. The UE monitors Short Messages transmitted with P-RNTI over DCI; monitors a Paging channel for CN paging using 5G-S-TMSI and RAN paging using fullI-RNTI; performs neighbouring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfers of unicast data to/from UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

Downlink control in fifth generation wireless communication system: In the fifth generation wireless communication system, physical downlink control channel (PDCCH) is used to schedule DL (downlink) transmissions on PDSCH (physical downlink shared channel) and UL (uplink) transmissions on PUSCH (physical uplink shared channel), where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ (hybrid automatic repeat request) information related to UL-SCH (downlink shared channel). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC (transmit power control) commands for PUCCH and PUSCH; Transmission of one or more TPC commands for SRS (sounding reference signal) transmissions by one or more UEs; Switching a UE's active bandwidth part; Initiating a random access procedure. A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations are signaled by gNB for each configured BWP (bandwidth part) wherein each search configuration is uniquely identified by an identifier. Identifier of search space configuration to be used for specific purpose such as paging reception, SI reception, random access response reception is explicitly signaled by the gNB. In NR, search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of CORESET configuration associated with it. A list of CORESET configurations are signalled by gNB for each configured BWP wherein each CORESET configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS (subcarrier spacing) is predefined in NR. Each CORESET configuration is associated with a list of TCI (Transmission configuration indicator) states. One DL RS ID (SSB (synchronization signal) or CSI RS (channel state information reference signal)) is configured per TCI state. The list of TCI states corresponding to a CORESET configuration is signalled by gNB via RRC signaling. One of the TCI state in TCI state list is activated and indicated to UE by gNB. TCI state indicates the DL TX beam (DL TX beam is QCLed with SSB/CSI RS of TCI state) used by gNB for transmission of PDCCH in the PDCCH monitoring occasions of a search space.

Bandwidth part in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a bandwidth part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, the UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH (DCI) indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a serving cell is indicated by either RRC or PDCCH. For unpaired spectrum, a DL BWP is paired with a UL BWP, and BWP switching is common for both UL and DL. Upon expiry of BWP inactivity timer, the UE switches the active DL BWP to the default DL BWP or initial DL BWP (if default DL BWP is not configured). In RRC_IDLE and RRC_INACTIVE state, the UE receives downlink transmission from the gNB in initial DL BWP and the UE transmits uplink transmissions in initial UL BWP. Initial DL BWP configuration is signaled by the field initialDownlinkBWP in system information (e.g., SIB1). Initial UL BWP configuration is signaled by the field initialUplinkBWP in system information (e.g., SIB1).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, the UE first transmits random access preamble (also referred as Msg1) and then waits for random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by the gNB can be multiplexed in the same RAR media access control (MAC) protocol data unit (PDU) by the gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and the UE has not yet transmitted the RA preamble for a configurable (configured by gNB in RACH configuration) number of times, the UE goes back to first step i.e. selects random access resource (preamble/RACH occasion) and transmits the RA preamble. A backoff may be applied before going back to first step.

If the RAR corresponding to its RA preamble transmission is received, the UE transmits message 3 (Msg3) in UL grant received in the RAR. Msg3 includes message such as RRC connection request, RRC connection re-establishment request, RRC handover confirm, scheduling request, SI request etc. It may include the UE identity (i.e. cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to C-RNTI included in Msg3, the contention resolution is considered successful, the contention resolution timer is stopped, and the RA procedure is completed. While the contention resolution timer is running, if the UE receives contention resolution MAC control element (CE) including the UE's contention resolution identity (first X bits of common control channel (CCCH) service data unit (SDU) transmitted in Msg3), the contention resolution is considered successful, the contention resolution timer is stopped, and the RA procedure is completed. If the contention resolution timer expires and the UE has not yet transmitted the RA preamble for a configurable number of times, the UE goes back to first step i.e. selects random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for secondary cell (SCell), etc. Evolved node B (eNB) assigns to UE dedicated Random access preamble. The UE transmits the dedicated RA preamble. The eNB transmits the RAR on a PDSCH addressed to RA-RNTI. The RAR conveys RA preamble identifier and timing alignment information. The RAR may also include UL grant. The RAR is transmitted in RAR window similar to contention based RA (CBRA) procedure. CFRA is considered successfully completed after receiving the RAR including RA preamble identifier (RAPID) of RA preamble transmitted by the UE. In case the RA is initiated for beam failure recovery, CFRA is considered successfully completed if PDCCH addressed to C-RNTI is received in search space for beam failure recovery. If the RAR window expires and the RA is not successfully completed and the UE has not yet transmitted the RA preamble for a configurable (configured by gNB in RACH configuration) number of times, the UE retransmits the RA preamble.

For certain events such has handover and beam failure recovery, if dedicated preamble(s) are assigned to a UE, during first step of random access i.e. during random access resource selection for Msg1 transmission, the UE determines whether to transmit dedicated preamble or non dedicated preamble. The dedicated preamble(s) is typically provided for a subset of SSBs/CSI RSs. If there is no SSB/CSI RS having DL RSRP (reference-signal received power) above a threshold amongst the SSBs/CSI RSs for which contention free random access resources (i.e. dedicated preambles/ROs) are provided by the gNB, the UE selects non dedicated preamble. Otherwise the UE selects dedicated preamble. So during the RA procedure, one random access attempt can be CFRA while other random access attempt can be CBRA.

2 step contention based random access (2 step CBRA): In the first step, the UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as MsgB. Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, the UE performs contention resolution using the contention resolution information in MsgB. The contention resolution is successful if the contention resolution identity received in MsgB matches first 48 bits of CCCH (common control channel) SDU (service data unit) transmitted in MsgA. If C-RNTI was transmitted in MsgA payload, the contention resolution is successful if the UE receives PDCCH addressed to C-RNTI. If contention resolution is successful, the random access procedure is considered successfully completed. Instead of contention resolution information corresponding to the transmitted MsgA, MsgB may include fallback information corresponding to the random access preamble transmitted in MsgA. If the fallback information is received, the UE transmits Msg3 and performs contention resolution using Msg4 as in CBRA procedure. If the contention resolution is successful, the random access procedure is considered successfully completed. If the contention resolution fails upon fallback (i.e. upon transmitting Msg3), the UE retransmits MsgA. If configured window in which the UE monitor network response after transmitting MsgA expires and the UE has not received MsgB including contention resolution information or fallback information as explained above, the UE retransmits MsgA. If the random access procedure is not successfully completed even after transmitting the MsgA configurable number of times, the UE fallbacks to 4 step RACH procedure i.e. the UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include UE ID (e.g. random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI (international mobile subscriber identity), idle mode ID, inactive mode ID, etc. The UE ID can be different in different scenarios in which the UE performs the RA procedure. When the UE performs RA after power on (before it is attached to the network), then the UE ID is the random ID. When the UE performs RA in IDLE state after it is attached to network, the UE ID is S-TMSI. If the UE has an assigned C-RNTI (e.g. in connected state), the UE ID is C-RNTI. In case the UE is in INACTIVE state, the UE ID is resume ID. In addition to the UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/TRP (transmit/receive point) switching indication, connection re-establishment indication, reconfiguration complete or handover complete message, etc.

2 step contention free random access (2 step CFRA): In this case the gNB assigns to UE dedicated Random access preamble(s) and PUSCH resource(s) for MsgA transmission. RO(s) to be used for preamble transmission may also be indicated. In the first step, the UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. The response is also referred as MsgB.

Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If the UE receives PDCCH addressed to C-RNTI, the random access procedure is considered successfully completed. If the UE receives fallback information corresponding to its transmitted preamble, the random access procedure is considered successfully completed.

For certain events such has handover and beam failure recovery, if dedicated preamble(s) and PUSCH resource(s) are assigned to the UE, during first step of random access i.e. during random access resource selection for MsgA transmission, the UE determines whether to transmit dedicated preamble or non-dedicated preamble. Dedicated preamble(s) is typically provided for a subset of SSBs/CSI RSs. If there is no SSB/CSI RS having DL RSRP above a threshold amongst the SSBs/CSI RSs for which contention free random access resources (i.e. dedicated preambles/ROs/PUSCH resources) are provided by the gNB, the UE selects non dedicated preamble. Otherwise the UE selects dedicated preamble. So during the RA procedure, one random access attempt can be 2 step CFRA while other random access attempt can be 2 step CBRA.

Upon initiation of random access procedure, the UE first selects the carrier (SUL or NUL). If the carrier to use for the random access procedure is explicitly signalled by the gNB, the UE select the signalled carrier for performing random access procedure. If the carrier to use for the random access procedure is not explicitly signalled by the gNB; and if the serving cell for the random access procedure is configured with supplementary uplink and if the RSRP of the downlink pathloss reference is less than rsrp-ThresholdSSB-SUL: the UE selects the SUL carrier for performing random access procedure. Otherwise, the UE selects the NUL carrier for performing random access procedure. Upon selecting the UL carrier, the UE determines the UL and DL BWP for random access procedure as specified in section 5.15 of TS 38.321. The UE then determines whether to perform 2 step or 4 step RACH for this random access procedure.
If this random access procedure is initiated by PDCCH order and if the ra-PreambleIndex explicitly provided by PDCCH is not 0b000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
if RSRP of the downlink pathloss reference is below a configured threshold, UE selects 4 step RACH. Otherwise UE selects 2 step RACH.

In the current design, the gNB can send PDCCH for BWP switching to the UE. If a PDCCH for BWP switching is received, and the MAC entity (of the UE) switches the active DL BWP to the DL BWP indicated by the PDCCH, the UE/MAC entity in the UE performs the following operation:
if the defaultDownlinkBWP-Id is configured, and the MAC entity/UE switches to the DL BWP which is not indicated by the defaultDownlinkBWP-Id and is not indicated by the dormantBWP-Id if configured:
   start or restart the bwp-InactivityTimer associated with the active DL BWP.
if the defaultDownlinkBWP-Id is not configured, and the MAC entity switches to the DL BWP which is not the initialDownlinkBWP and is not indicated by the dormantBWP-Id if configured:
   start or restart the bwp-Inactivity Timer associated with the active DL BWP.

One or more DL BWPs are configured by the gNB in RRCReconfiguration message. Each of these configured DL BWPs has a BWP ID. The gNB may indicate which one of these configured DL BWPs is default DL BWP by signaling parameter default-DownlinkBWP-Id. The parameter defaultDownlinkBWP-Id is set to the BWP ID of DL BWP which is default DL BWP. Similarly, the gNB may indicate which one of these configured DL BWPs is dormant DL BWP by signaling parameter dormantBWP-Id. The parameter dormantBWP-Id is set to the BWP ID of DL BWP which is dormant DL BWP. If the active DL BWP is a dormant DL BWP, the UE stops monitoring PDCCH and transmitting SRS/PUSCH/PUCCH but continues performing CSI measurements, AGC (automatic gain control), and beam management, if configured. Note that the dormantBWP-Id may be configured for a secondary cell (SCell) and not for an SpCell (i.e. PCell or PSCell).

In the current design, one initial Uplink BWP (indicated by initialUplinkBWP) and one initial downlink BWP (indicated by initialDownlinkBWP) is configured in a cell. In order to support reduced capability UEs (RedCap UE(s)), additional initial uplink BWP (indicated by initialUplinkBWP-RedCap) can be configured on uplink carrier of serving cell and an additional downlink BWP (indicated by initialDownlinkBWP-RedCap) can be configured on downlink carrier of serving cell.

In the scenario where defaultDownlinkBWP-Id is not configured by the gNB and initialDownlinkBWP-RedCap is configured, upon receiving PDCCH for BWP switching to initialDownlinkBWP-RedCap, as per the current spec, the UE unnecessarily starts or restarts the bwp-InactivityTimer. This may further result in switching to initial-DownlinkBWP when bwp-Inactivity Timer expires. When the initialDownlinkBWP-RedCap is configured, the Redcap UE should not further switch to initial-DownlinkBWP as initialDownlinkBWP-RedCap is optimised for the Redcap UE.

RedCap UE is a UE with following reduced capability:
The maximum bandwidth is 20 MHz for FR1 (frequency range 1), and is 100 MHz for FR2. The UE features and corresponding capabilities related to the UE bandwidths wider than 20 MHz in FR1 or wider than 100 MHz in FR2 are not supported by RedCap UEs;
The maximum mandatory supported DRB (data radio bearer) number is 8;
The mandatory supported PDCP (packet data convergence protocol) SN (sequence number) length is 12 bits while 18 bits being optional;
The mandatory supported RLC (radio link control) AM (acknowledged mode) SN length is 12 bits while 18 bits being optional;
For FR 1, 1 DL MIMO layer if 1 Rx branch is supported, and 2 DL MIMO layers if 2 Rx branches are supported; for FR2, either 1 or 2 DL MIMO layers can be supported, while 2 Rx branches are always supported. For FR1 and FR2, UE features and corresponding capabilities related to more than 2 UE Rx branches or more than 2 DL MIMO layers, as well as UE features and capabilities related to more than 2 UE TX branches or more than 2 UL MIMO layers are not supported by RedCap UEs;
CA (carrier aggregation), MR-DC (multi-radio dual connectivity), DAPS (dual active protocol stack), CPAC (conditional PSCell addition/change) and IAB (integrated access backhaul) (i.e., the RedCap UE is not expected to act as IAB node) related UE features and corresponding capabilities are not supported by RedCap UEs.

A RedCap UE sends the parameter supportOfRedCap-r17 in UE capability information message to a gNB in RRC_CONNECTED state, so that the gNB can know whether the UE is a RedCap UE or not. supportOfRedCap-r17 indicates that the UE is a RedCap UE with comprised of at least the following functional components:
Maximum FR1 RedCap UE bandwidth is 20 MHz;
Maximum FR2 RedCap UE bandwidth is 100 MHz;
Support of RedCap early indication based on Msg1, MsgA and Msg3 for random access;
Separate initial UL BWP for RedCap UEs;
Separate initial DL BWP for RedCap UEs.

A UE is in RRC_CONNECTED. The UE receives RRCReconfiguration message from the gNB. The RRCReconfiguration message includes configuration of one or more dedicated DL BWPs and one or more dedicated UL BWPs for each serving cell(s). The gNB may indicate which one of these configured DL BWPs is default DL BWP by signaling parameter defaultDownlinkBWP-Id. The parameter default-DownlinkBWP-Id is set to the BWP ID of DL BWP which is default DL BWP. Similarly, the gNB may indicate which one of these configured DL BWPs is dormant DL BWP by signaling parameter dormantBWP-Id. The parameter dormantBWP-Id is set to the BWP ID of DL BWP which is dormant DL BWP. Note that the dormantBWP-Id may be configured for a secondary cells (SCells) and not for an SpCell (i.e. PCell or PSCell). The gNB may indicate which one of these configured DL BWPs as first active DL BWP by signaling parameter firstActiveDownlinkBWP-Id. The gNB may indicate which one of these configured UL BWPs as first active UL BWP by signaling parameter firstActiveUplinkBWP-Id. The gNB may also configure bwp-InactivityTimer for zero, one or more serving cell(s) in the RRCReconfiguration message.

For SpCell the DL BWP and the UL BWP indicated by firstActiveDownlinkBWP-Id and firstActiveUplinkBWP-Id are activated upon receiving the RRCReconfiguration message. For SCell(s), if a SCell is configured with sCellState set to activated upon SCell configuration, or a SCell Activation/Deactivation MAC CE or an Enhanced SCell Activation/Deactivation MAC CE is received activating the SCell: the DL BWP and the UL BWP indicated by firstActiveDownlinkBWP-Id and firstActiveUplinkBWP-Id for that SCell are activated.

The MAC entity or the UE shall for each activated Serving Cell configured with bwp-InactivityTimer perform the following operation:
1> if a PDCCH for BWP switching is received, and the MAC entity/the UE switches the active DL BWP (in other words, the PDCCH is received and DCI indicates the UE to switch the active DL BWP of the serving cell to one of the configured DL BWPs different from the current active DL BWP, the UE switches its active DL BWP to the DL BWP indicated in the DCI):
2> if the defaultDownlinkBWP-Id is configured, and the MAC entity/the UE switches to the DL BWP which is not indicated by the defaultDownlinkBWP-Id and is not indicated by the dormantBWP-Id if configured; or
2> if the defaultDownlinkBWP-Id is not configured, and if the UE is not a RedCap UE, and the MAC entity/the UE switches to the DL BWP which is not the initial-DownlinkBWP and is not indicated by the dormantBWP-Id if configured; or
2> if the defaultDownlinkBWP-Id is not configured and if the UE is a RedCap UE, and initialDownlinkBWP-RedCap is not configured, and the MAC entity/the UE switches to the DL BWP which is not the initialDownlinkBWP and is not indicated by the dormantBWP-Id if configured; or
2> if the defaultDownlinkBWP-Id is not configured and if the UE is a RedCap UE, and initialDownlinkBWP-RedCap is configured, and the MAC entity/the UE switches to the DL BWP which is not the initialDownlinkBWP-RedCap, and is not indicated by the dormantBWP-Id if configured:
3> start or restart the bwp-InactivityTimer associated with the active DL BWP (note that here the active DL BWP is the DL BWP to which the UE has switched upon receiving the BWP switching command).

Note that if the RedCap UE does not support a carrier aggregation (i.e. does not support SCells), the dormantBWP-Id will not be configured by the gNB as the dormantBWP-Id is for the SCells. Such RedCap UE may skip checking the condition ‘is not indicated by the dormantBWP-Id if configured’ in the above operation as the dormantBWP-Id is never configured for such RedCap UE.

The gNB shall for each activated Serving Cell configured with bwp-InactivityTimer, of a UE, perform the following operation (Note that the gNB can know whether the UE is a RedCap UE based on the UE capability transmitted by the UE to the gNB):
1> if a PDCCH for DL BWP switching for the serving cell is transmitted to the UE (in other words, the PDCCH is transmitted and DCI indicates the UE to switch the active DL BWP of the serving cell to one of the configured DL BWPs different from the current active DL BWP and the gNB switches the active DL BWP of the serving cell for the UE to the indicated DL BWP in DCI):
2> if the defaultDownlinkBWP-Id is configured for the serving cell, and the gNB switches to the DL BWP which is not indicated by the default DownlinkBWP-Id and is not indicated by the dormantBWP-Id if configured; or
2> if the defaultDownlinkBWP-Id is not configured, and if the UE is not a RedCap UE, and the gNB switches to the DL BWP which is not the initialDownlinkBWP and is not indicated by the dormantBWP-Id if configured; or
2> if the default DownlinkBWP-Id is not configured and if the UE is a RedCap UE, and initialDownlinkBWP-RedCap is not configured, and the gNB switches to the DL BWP which is not the initialDownlinkBWP and is not indicated by the dormantBWP-Id if configured; or
2> if the defaultDownlinkBWP-Id is not configured and if the UE is a RedCap UE, and initialDownlinkBWP-RedCap is configured, and the gNB switches to the DL BWP which is not the initialDownlinkBWP-RedCap, and is not indicated by the dormantBWP-Id if configured:
3> start or restart the bwp-InactivityTimer associated with the active DL BWP (note that here active DL BWP is the DL BWP to which gNB has switched upon transmitting the BWP switching command).

Note that if the RedCap UE does not support a carrier aggregation (i.e. does not support SCells), dormantBWP-Id will not be configured by the gNB as the dormantBWP-Id is for the SCells. For such RedCap UE, the gNB may skip checking the condition ‘is not indicated by the dormantBWP-Id if configured’ in the above operation as the dormantBWP-Id is never configured for such RedCap UE.

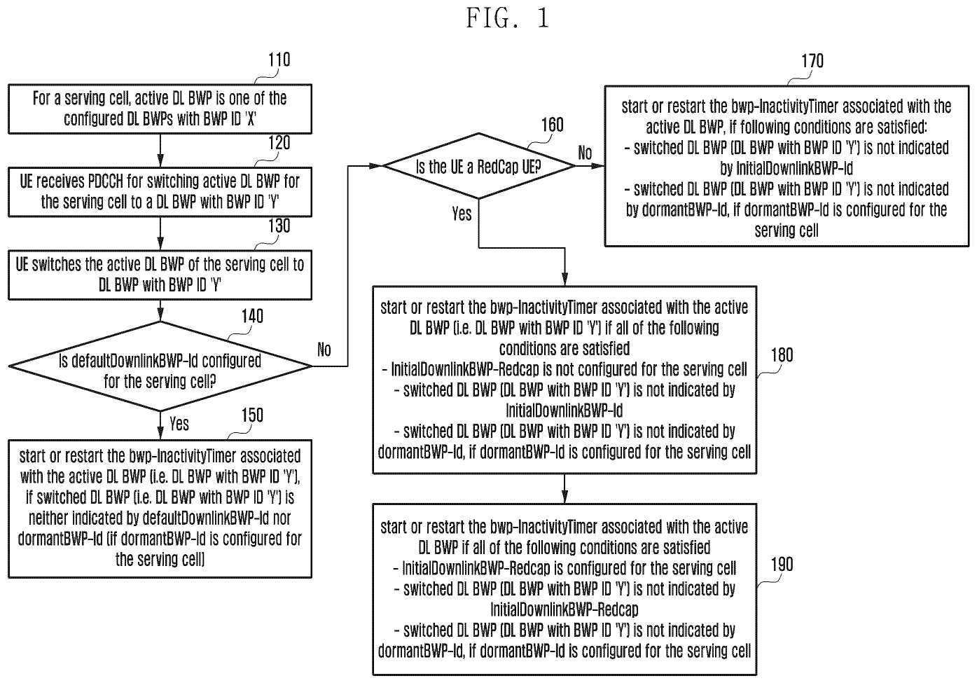

In an embodiment of the disclosure, the UE operation for a serving cell is shown in FIG. 1 below.

FIG. 1 is an example illustration of starting or restarting of a BWP inactivity timer according to this method of disclosure.

Referring to FIG. 1, in step 110, The UE receives RRCReconfiguration message from the gNB. The RRCReconfiguration message includes configuration of one or more dedicated DL BWPs and one or more dedicated UL BWPs for each serving cell(s). The gNB may indicate which one of these configured DL BWPs is default DL BWP by signaling parameter defaultDownlinkBWP-Id. The parameter defaultDownlinkBWP-Id is set to the BWP ID of DL BWP which is default DL BWP. Similarly, the gNB may indicate which one of these configured DL BWPs is dormant DL BWP by signaling parameter dormantBWP-Id. The parameter dormantBWP-Id is set to the BWP ID of DL BWP which is dormant DL BWP. The gNB may indicate which one of these configured DL BWPs as first active DL BWP by signaling parameter firstActive-DownlinkBWP-Id. The gNB may indicate which one of these configured UL BWPs as first active UL BWP by signaling parameter firstActiveUplinkBWP-Id. The gNB may also configure bwp-InactivityTimer for zero, one or more serving cell(s) in the RRCRe-configuration message. And, for a serving cell, an active DL BWP is activated. The activated DL BWP is one of the configured DL BWPs with BWP ID ‘X.’ In an embodiment, the activated DL BWP is one of an initial DL BWP indicated by the default-DownlinkBWP-Id or a first active DL BWP indicated by the firstActiveDownlinkBWP-Id or a DL BWP indicated by the DCI comprising information on the DL BWP to be activated.

In step 120, the UE/the MAC entity receives PDCCH for switching the active DL BWP for the serving cell to a DL BWP with BWP ID ‘Y.’ In an embodiment, the information of the DL BWP with BWP ID ‘Y’ is included in DCI. The DL BWP with BWP ID ‘Y’ is one of the configured DL BWPs different from the current active DL BWP with BWP ID ‘X.’

In step 130, the UE/the MAC entity switches the active DL BWP of the serving cell to the DL BWP with BWP ID ‘Y.’

In step 140, the UE/the MAC entity determines whether the defaultDownlinkBWP-Id is configured for the serving cell.

In case that the defaultDownlinkBWP-Id is configured for the serving cell, in step 150, the UE/the MAC entity determines whether the switched DL BWP (i.e. the DL BWP with BWP ID ‘Y’) is neither indicated by the defaultDownlinkBWP-Id nor is indicated by the dormantBWP-Id if the dormantBWP-Id is configured for the serving cell. In case that the defaultDownlinkBWP-Id is configured for the serving cell, the switched DL BWP (i.e. the DL BWP with BWP ID ‘Y’) is not indicated by the default-DownlinkBWP-Id and is not indicated by the dormantBWP-Id if the dormantBWP-Id is configured for the serving cell, the UE/the MAC entity starts or restarts the bwp-InactivityTimer associated with the active DL BWP (i.e. the DL BWP with BWP ID ‘Y’).

In case that the defaultDownlinkBWP-Id is configured for the serving cell, in step 160, the UE/the MAC entity determines whether the UE is a RedCap UE.

In case that the UE is not the RedCap UE, in step 170, the UE/the MAC entity determines whether the switched DL BWP (i.e. the DL BWP with BWP ID ‘Y’) is neither indicated by the initialDownlinkBWP nor is indicated by the dormantBWP-Id if the dormantBWP-Id is configured for the serving cell. In case that the default-DownlinkBWP-Id is not configured for the serving cell and the UE is not the RedCap UE, the switched DL BWP (i.e. the DL BWP with BWP ID ‘Y’) is not indicated by the nitialDownlinkBWP and is not indicated by the dormantBWP-Id if the dormantBWP-Id is configured for the serving cell, the UE/the MAC entity starts or restarts the bwp-InactivityTimer associated with the active DL BWP.

In case that the UE is the RedCap UE, in step 180, the UE/the MAC entity determines whether the initialDownlinkBWP-RedCap is not configured for the serving cell, and the switched DL BWP (i.e. the DL BWP with BWP ID ‘Y’) is neither indicated by the initialDownlinkBWP nor is indicated by the dormantBWP-Id if the dormantBWP-Id is configured for the serving cell. In case that the default-DownlinkBWP-Id is not configured for the serving cell and the UE is the RedCap UE, the initialDownlinkBWP-RedCap is not configured for the serving cell, and the switched DL BWP (i.e. the DL BWP with BWP ID ‘Y’) is not indicated by the nitial-DownlinkBWP and is not indicated by the dormantBWP-Id if the dormantBWP-Id is configured for the serving cell, the UE/the MAC entity starts or restarts the bwp-InactivityTimer associated with the active DL BWP.

In step 190, the the UE/the MAC entity determines whether the initialDownlinkBWP-RedCap is configured for the serving cell and the switched DL BWP (i.e. the DL BWP with BWP ID ‘Y’) is neither indicated by the initialDownlinkBWP-RedCap nor is indicated by the dormantBWP-Id if the dormantBWP-Id is configured for the serving cell. In case that the defaultDownlinkBWP-Id is not configured for the serving cell and the UE is the RedCap UE, the initialDownlinkBWP-RedCap is configured for the serving cell, and the switched DL BWP (i.e. the DL BWP with BWP ID ‘Y’) is not indicated by the initialDownlinkBWP-RedCap and is not indicated by the dormantBWP-Id if the dormantBWP-Id is configured for the serving cell, the UE/the MAC entity starts or restarts the bwp-InactivityTimer associated with the active DL BWP.

In an embodiment of this disclosure, upon initiation of the random access procedure, after selection of the carrier (NUL or SUL) for performing random access procedure as explained earlier, if the UE is a RedCap UE and the UE is in the RRC_IDLE or the RRC_INACTIVE mode, the MAC entity/the UE shall:
1> if initialUplinkBWP-RedCap is configured for the selected carrier:
2> perform the random access procedure as explained earlier by using the BWP configured by initialUplinkBWP-RedCap.
1> else:
2> perform the random access procedure as explained earlier by using the BWP configured by initialUplinkBWP.
1> if initialDownlinkBWP-RedCap is configured:
2> monitor the PDCCH on the BWP configured by initialDownlinkBWP-RedCap.
1> else:
2> monitor the PDCCH on the BWP configured by initialDownlinkBWP.

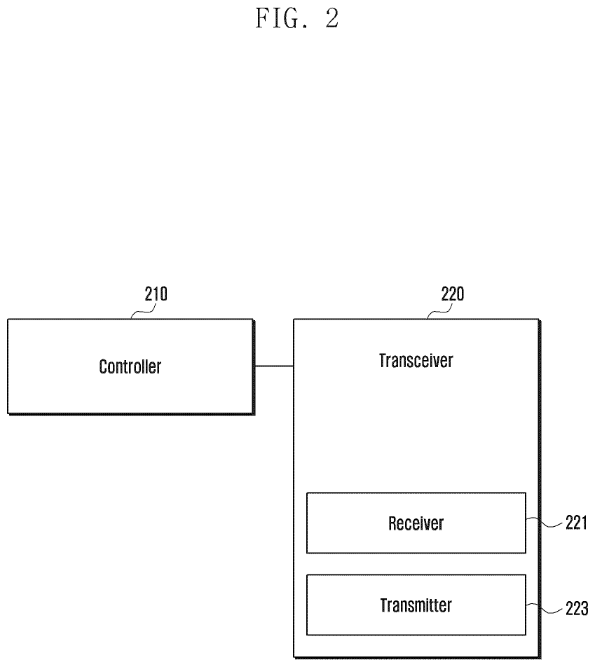

FIG. 2 is a diagram illustrating a configuration of a terminal according to the disclosure.

The terminal (UE) according to an embodiment of the disclosure may include a transceiver 220 and a controller 210 that controls the overall operation of the terminal. The transceiver 220 may include a transmitter 221 and a receiver 223.

The transceiver 220 may transmit and receive signals to and from other network entities.

The controller 210 may control the terminal to perform one operation in the above-described embodiments. Meanwhile, the controller 210 and the transceiver 220 do not have to be implemented as separated modules but may be implemented as one element such as a single chip. The controller 210 and the transceiver 220 may be electrically connected. For example, the controller 210 may be a circuit, an application-specific circuit, or at least one processor. Further, the operations of the terminal may be performed by including a memory device storing a corresponding program code in a predetermined element within the terminal.

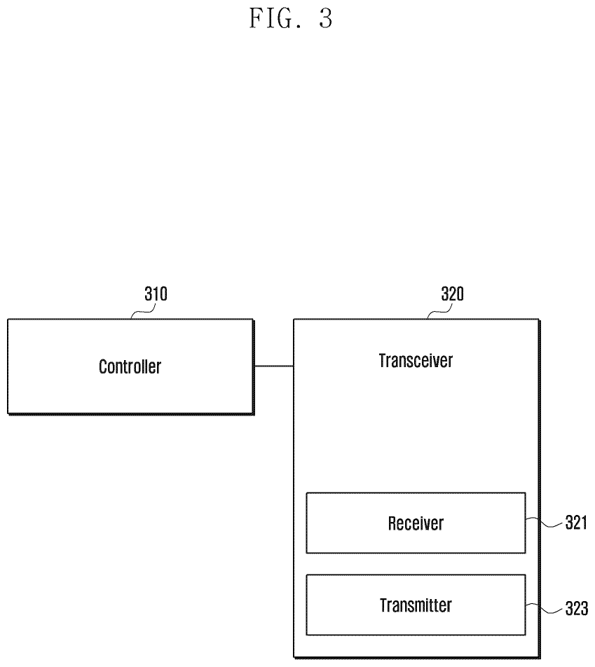

FIG. 3 is a diagram illustrating a configuration of a base station according to the disclosure.

The base station according to an embodiment of the disclosure may include a transceiver 320 and a controller 310 that controls the overall operation of the base station. The transceiver 320 may include a transmitter 321 and a receiver 323.

The transceiver 320 may transmit and receive signals to and from network entities and the terminal.

The controller 310 may control the base station to perform one operation in the above-described embodiments. Meanwhile, the controller 310 and the transceiver 320 do not have be implemented as separated modules but may be implemented as one element such as a single chip. The controller 310 and the transceiver 320 may be electrically connected. For example, the controller 310 may be a circuit, an application-specific circuit, or at least one processor. Further, the operations of the base station may be performed by including a memory device storing a corresponding program code in a predetermined element within the base station.

It should be noted that the block diagrams, example diagrams of a control/data signal transmission method, example diagrams of an operation procedure, and diagrams illustrated in FIGS. 1 to 3 have no intent to limit the scope of the disclosure. That is, it should not be construed that all element parts, entities, or operations shown in FIGS. 1 to 3 are essential elements for implementing the disclosure, and it should be understood that only a few elements may implement the disclosure within the scope without departing the subject matter of the disclosure.

The operations of the base station or the UE may be performed when a predetermined element within the base station or the UE apparatus includes a memory device storing the corresponding program code. That is, the controller of the base station or the UE apparatus may perform the operations by reading and executing the program code stored in the memory device through a processor or a Central Processing Unit (CPU).

Various elements and modules of the entity, the base station, or the UE used in the specification may operate by using a hardware circuit, for example, a combination of a complementary metal oxide semiconductor-based logical circuit, firmware, software and/or hardware, or a combination of firmware and/or software inserted into a machine-readable medium. For example, various electrical structures and methods may be performed using transistors, logic gates, and electrical circuits such as application specific integrated circuit.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary.

1. A method performed by a terminal in a wireless communication system, the method comprising:
receiving, from a base station, a first message comprising configuration information related to at least one bandwidth part;
receiving, from the base station, a second message comprising information indicating an active downlink bandwidth part from the at least one bandwidth part;
switching to the active downlink bandwidth part;
in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, starting or restarting a timer associated with a bandwidth part inactivity.

2. The method of claim 1, further comprising:
in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, starting or restarting the timer associated with the bandwidth part inactivity.

3. The method of claim 1, further comprising:
in case that the terminal is not the terminal of the reduced capability, the default downlink bandwidth part is not configured, and the active downlink bandwidth part is not the initial downlink bandwidth part and is not indicated by an identity of a dormant bandwidth part, starting or restarting the timer associated with the bandwidth part inactivity.

4. The method of claim 1, further comprising:
in case that the default downlink bandwidth part is configured, and the active downlink bandwidth part is not indicated by an identity of the default downlink bandwidth part and is not indicated by an identity of a dormant bandwidth part, starting or restarting the timer associated with the bandwidth part inactivity.

5. The method of claim 1, wherein the first message comprises a radio resource control (RRC) reconfiguration message, and
wherein the second message comprises downlink control information (DCI).

6. A method performed by a base station in a wireless communication system, the method comprising:
transmitting, to a terminal, a first message comprising configuration information related to at least one bandwidth part;
transmitting, to the terminal, a second message comprising information indicating an active downlink bandwidth part from the at least one bandwidth part; and
in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, starting or restarting a timer associated with a bandwidth part inactivity.

7. The method of claim 6, further comprising:
in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, starting or restarting the timer associated with the bandwidth part inactivity.

8. The method of claim 6, further comprising:
in case that the terminal is not the terminal of the reduced capability, the default downlink bandwidth part is not configured, and the active downlink bandwidth part is not the initial downlink bandwidth part and is not indicated by an identity of a dormant bandwidth part, starting or restarting the timer associated with the bandwidth part inactivity.

9. The method of claim 6, further comprising:
in case that the default downlink bandwidth part is configured, and the active downlink bandwidth part is not indicated by an identity of the default downlink bandwidth part and is not indicated by an identity of a dormant bandwidth part, starting or restarting the timer associated with the bandwidth part inactivity.

10. The method of claim 6, wherein the first message comprises a radio resource control (RRC) reconfiguration message, and
wherein the second message comprises downlink control information (DCI).

11. A terminal in a wireless communication system, the terminal comprising:
a transceiver; and
a controller coupled with the transceiver and configured to:
receive, from a base station, a first message comprising configuration information related to at least one bandwidth part.
receive, from the base station, a second message comprising information indicating an active downlink bandwidth part from the at least one bandwidth part,
switch to the active downlink bandwidth part,
in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, start or restart a timer associated with a bandwidth part inactivity.

12. The terminal of claim 11, wherein the controller is further configured to:
in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, start or restart the timer associated with the bandwidth part inactivity.

13. The terminal of claim 11, wherein the controller is further configured to:
in case that the terminal is not the terminal of the reduced capability, the default downlink bandwidth part is not configured, and the active downlink bandwidth part is not the initial downlink bandwidth part and is not indicated by an identity of a dormant bandwidth part, start or restart the timer associated with the bandwidth part inactivity.

14. The terminal of claim 11, wherein the controller is further configured to:
in case that the default downlink bandwidth part is configured, and the active downlink bandwidth part is not indicated by an identity of the default downlink bandwidth part and is not indicated by an identity of a dormant bandwidth part, start or restart the timer associated with the bandwidth part inactivity.

15. The terminal of claim 1, wherein the first message comprises a radio resource control (RRC) reconfiguration message, and
wherein the second message comprises downlink control information (DCI).

16. A base station in a wireless communication system, the base station comprising:
a transceiver; and
a controller coupled with the transceiver and configured to:
transmit, to a terminal, a first message comprising configuration information related to at least one bandwidth part,
transmit, to the terminal, a second message comprising information indicating an active downlink bandwidth part from the at least one bandwidth part, and
in case that the terminal is a terminal of a reduced capability, a default downlink bandwidth part is not configured, an initial downlink bandwidth part for the terminal of the reduced capability is not configured, and the active downlink bandwidth part is not an initial downlink bandwidth part for a serving cell, start or restart a timer associated with a bandwidth part inactivity.

17. The base station of claim 16, wherein the controller is further configured to:
in case that the terminal is the terminal of the reduced capability, the default downlink bandwidth part is not configured, the initial downlink bandwidth part for the terminal of the reduced capability is configured, and the active downlink bandwidth part is not the initial downlink bandwidth part for the terminal of the reduced capability, start or restart the timer associated with the bandwidth part inactivity.

18. The base station of claim 16, wherein the controller is further configured to:
in case that the terminal is not the terminal of the reduced capability, the default downlink bandwidth part is not configured, and the active downlink bandwidth part is not the initial downlink bandwidth part and is not indicated by an identity of a dormant bandwidth part, start or restart the timer associated with the bandwidth part inactivity.

19. The base station of claim 16, wherein the controller is further configured to:
in case that the default downlink bandwidth part is configured, and the active downlink bandwidth part is not indicated by an identity of the default downlink bandwidth part and is not indicated by an identity of a dormant bandwidth part, start or restart the timer associated with the bandwidth part inactivity.

20. The base station of claim 16, wherein the first message comprises a radio resource control (RRC) reconfiguration message, and
wherein the second message comprises downlink control information (DCI).
